(19) United States
(12) Patent Application Publication
(10) Pub. No.: US 2011/0300755 A1
(43) Pub. Date: Dec. 8, 2011

(54) CABLE CONNECTING DEVICE ASSEMBLY AND MANUFACTURING METHOD THEREOF

(75) Inventor: Ching-Wei Cheng, Keelung City (TW)

(73) Assignee: ACTION STAR ENTERPRISE CO., LTD., Sijhih (TW)

(21) Appl. No.: 12/793,153

(22) Filed: Jun. 3, 2010

(51) Int. Cl. H01R 13/66; H01R 43/00

(52) U.S. Cl. 439/620.22; 29/825

(57) ABSTRACT

The present invention relates to an improved cable connecting device assembly and a manufacturing method thereof, the improved cable connecting device assembly comprises: an electrical connector, a first circuit board, a second circuit board, at least one plugging member, at least one cable, a sheltering housing, and an outer housing, wherein the first circuit board and the second circuit board both having electronic circuits and electronic components are connected to the electrical connector, so as to facilitate the improved cable connecting device assembly possess not only the function of video signal transmission but more other functions; moreover, through the manufacturing method, the improved cable connecting device assembly is fabricated and has not only the function of video signal transmission but more other functions, besides, the whole thickness of the improved cable connecting device assembly is not increased.

### BACKGROUND OF THE INVENTION

1. Technical Field

The present invention relates to a cable connecting device assembly, and more particularly, to an improved cable connecting device assembly with an electrical connector connected to at least one circuit board, so as to facilitate the improved cable connecting device assembly possess not only the function of video signal transmission but more other functions.

2. Description of Related Art

A cable connecting device assembly is widely adapted to connect two different electronic devices, moreover, with the development of nowadays technology and the change of the using manner of human, whatever the cable connecting device assembly is adapted as an external cable connecting device or an internal cable connecting device, the developing objectives of the cable connecting device assembly are miniaturization and easy to be assembled. In addition, a connector used to transmit video signal of the conventional cable connecting device assembly, i.e., a VGA connector, having a plurality of terminals arranged in three rows in the inside thereof due to constraint of the connecting interface.

Referring to FIG. 1, which illustrates a side view of the conventional cable connecting device assembly, as shown in FIG. 1, the conventional cable connecting device assembly 1 includes: an electrical connector 11a, a plurality of electrical wires 12a and an insulation sleeve 13a. The electrical connector 11a includes a body 111a disposed in the inside thereof; and a plurality of terminals 112a disposed in the inside of the electrical connector 11a with the body 111a, wherein the plurality of terminals 112a is covered by the body 111a. One end of the electrical wires 12a are respectively welding to the terminals 112a, and another end of the electrical wires 12a are wrapped by the insulation sleeve 13a. So that, the electrical wires 12a are housed in the insulation sleeve 13a and can not be connected to other electric components, for example, being connected to an electric chip or a circuit board; furthermore, for this reason, the conventional cable connecting device assembly 1a is merely used to transmit the video signal and can not to be expanded any other functions.

Referring to FIG. 2, which illustrates the side view of an another conventional cable connecting device assembly, as shown in FIG. 2, an another conventional cable connecting device assembly 1b includes an electrical connector 11b and a circuit board 12b; Wherein a plurality of terminals 111b protruding out of the electrical connector 11b are fastened on the circuit board 12b by way of penetrating through the circuit board 12b. For more easily fastening the terminals 111b to the circuit board 12b, it must increase whole length of the terminals 111b and make each terminal 111b has a specific bending angle, as shown in FIG. 2, the specific bending angle of the terminals is 90°. According to the above mention, it is well know that the manufacturing cost of the conventional cable connecting device assembly 1b is increased due to the design of lengthening the terminals 111b, besides, the design of making each terminal 111b possess the specific bending angle causes the increment of whole thickness of the conventional cable connecting device assembly 1b, therefore, that is not a ideal design.

Accordingly, in view of the drawbacks and shortcomings of the conventional cable connecting device assembly, the inventor of the present application has made great efforts to make inventive research thereon and eventually provided an improved cable connecting device assembly and a manufacturing method thereof according to the present invention.

### SUMMARY OF THE INVENTION

The primary objective of the present invention is to provide an improved cable connecting device assembly, in which, an electrical connector is connected to at least one circuit board, so as to facilitate the improved cable connecting device assembly possess not only the function of video signal transmission but more other functions.

The another objective of the present invention is to provide a manufacturing method for an improved cable connecting device assembly, through the manufacturing method, the improved cable connecting device assembly is fabricated and has not only the function of video signal transmission but more other functions, besides, the whole thickness of the improved cable connecting device assembly is not increased.

Accordingly, to achieve the abovementioned primary objective, the inventor proposes an improved cable connecting device assembly connected to an electronic device for transmitting signals, the improved cable connecting device assembly comprises: an electrical connector, a first circuit board, a second circuit board, at least one plugging member, at least one cable, a sheltering housing, and an outer housing.

The electrical connector, has an insulation body and a plurality of terminals, the plurality of terminals are wrapped by the insulation body; The first circuit board is connected to the terminals, wherein at least one first electric circuit and at least one electronic component are disposed on the first circuit board; The second circuit board is connected to the terminals, wherein at least one second electric circuit and the electronic component are disposed on the second circuit board; The plugging member is disposed between the first circuit board and the second circuit board and capable of electrically connecting to the first electric circuit and the second electric circuit; The cable had a plurality of conducting wires which can be connected to the first electric circuit and the second electric circuit by way of soldering; The sheltering housing is adapted to cover parts of the electrical connector, the first electric circuit, the second electric circuit, the plugging member, and part of the cable; The outer housing is used to wrap around the sheltering housing.

Moreover, to achieve the another objective mentioned above, the inventor proposes a manufacturing method for an improved cable connecting device assembly, the manufacturing method comprises the steps of: (1) fabricating an electrical connector with an insulation body and a plurality of terminals; (2) making a first circuit board; (3) welding the partial of the terminals to a first terminal soldering district on the first circuit board; (4) welding one end of a plugging member to a first plugging hole district in the first circuit board; (5) manufacturing a second circuit board; (6) welding the partial of the terminals to a second terminal soldering district on the second circuit board; (7) welding another end of the plugging member to a second plugging hole district on the second circuit board; (8) inspecting the semi-finished product of the improved cable connecting device assembly; (9) welding a plurality of conducting wires within a cable to a first conducting wire soldering district of the first circuit board and a second conducting wire soldering district of the second circuit board, respectively; (10) testing the semi-finished product of the improved cable connecting device assembly; (11) installing a sheltering housing; and (12) installing an outer housing.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a side view of a conventional cable connecting device assembly;

FIG. 2 is the side view of an another conventional cable connecting device assembly;

FIG. 3 is a stereo view of an improved cable connecting device assembly according to the present invention;

FIG. 4 is an exploded view of the improved cable connecting device assembly according to the present invention;

FIG. 5 is a top view of a first circuit board of the improved cable connecting device assembly;

FIG. 6 is the top view of a first circuit board of the improved cable connecting device assembly;

FIGS. 7A and 7B are flow charts of a manufacturing method for the improved cable connecting device assembly according to the present invention;

FIG. 8 is the top view of an electrical connector and the first circuit board of the improved cable connecting device assembly;

FIG. 9 is the top view of the electrical connector, the first circuit board and a plugging member of the improved cable connecting device assembly;

FIG. 10 is the top view of the electrical connector and the second circuit board of the improved cable connecting device assembly;

FIG. 11 is the top view of the electrical connector, the first circuit board, the second circuit board, and the plugging member of the improved cable connecting device assembly;

FIG. 12 is the top view of the electrical connector, the first circuit board, the second circuit board, the plugging member, and a cable of the improved cable connecting device assembly;

FIG. 13 is the top view of the electrical connector, the cable and a sheltering housing of the improved cable connecting device assembly;

FIG. 14 is the flow chart of the detailed steps of the step (702); and

FIG. 15 is the flow chart of the detailed steps of the step (705).

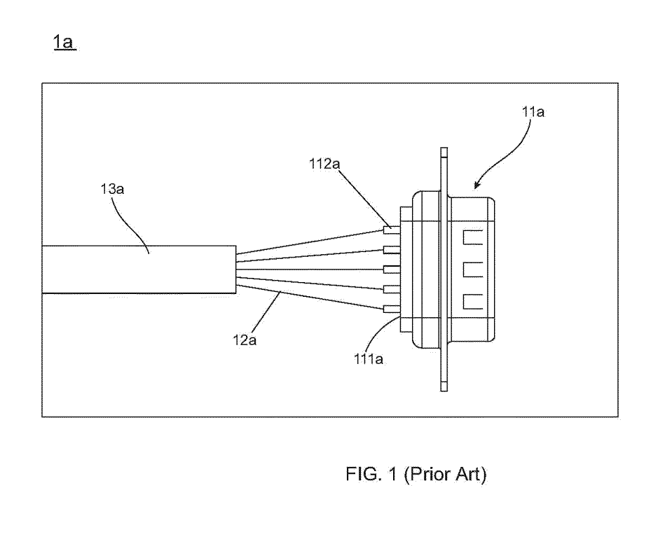

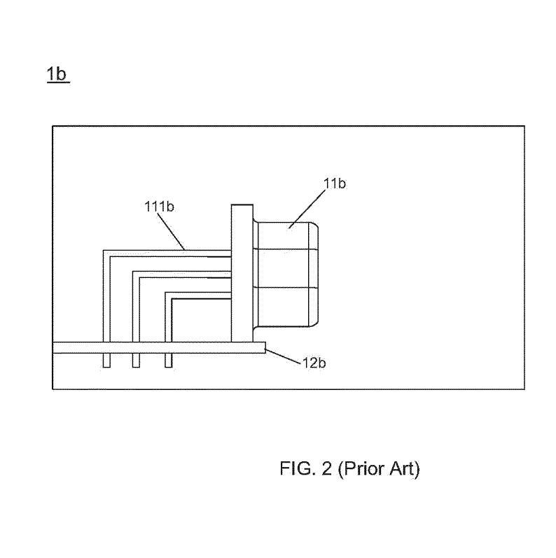

### DETAILED DESCRIPTION OF THE INVENTION

To more clearly describe an improved cable connecting device assembly and a manufacturing method thereof according to the present invention, an embodiment of the present invention will be described in detail with reference to the attached drawings hereinafter.

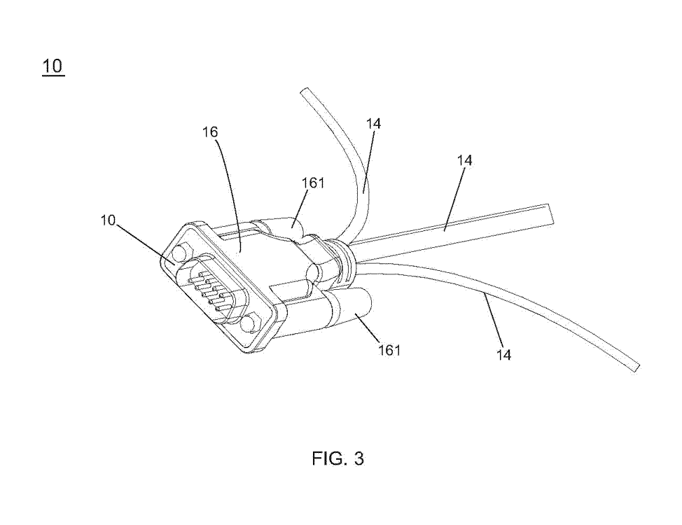

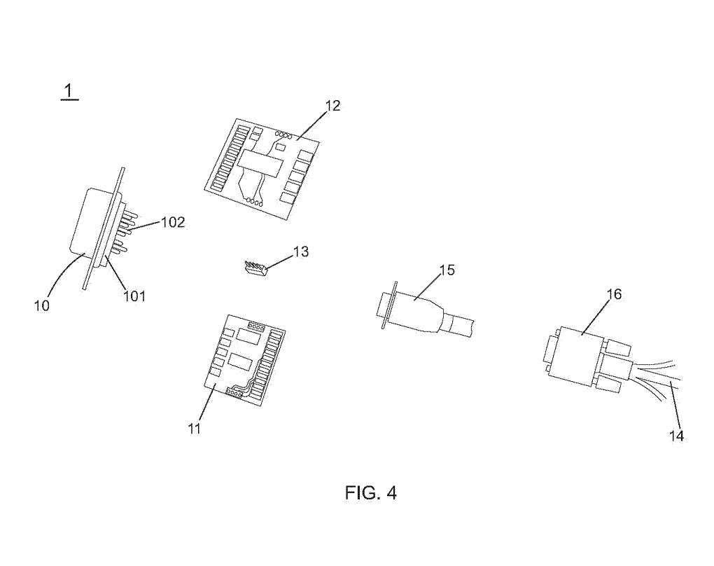

Referring to FIGS. 3 and 4 together, which respectively illustrate a stereo view and an exploded view of the improved cable connecting device assembly according to the present invention, the improved cable connecting device assembly 1 is used to connect an electronic device for transmitting signals, which includes: an electrical connector 10, a first circuit board 11, a second circuit board 12, a plugging member 13, at least one cable 14, a sheltering housing 15, and an outer housing 16.

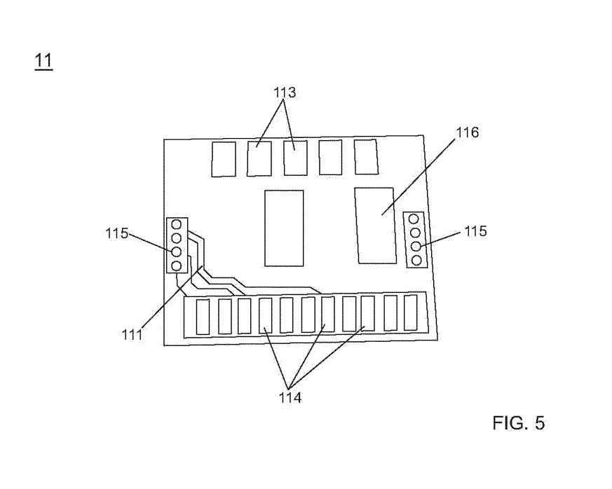

The electrical connector 10 has an insulation body 101 and a plurality of terminals 102, the plurality of terminals 102 are wrapped by the insulation body 101. The first circuit board 11 is connected to the terminals 102, please referring to FIG. 5 together, which illustrates a top view of the first circuit board of the improved cable connecting device assembly, a first terminal soldering district 113, a first conducting wire soldering district 114, at least one first plugging hole district 115, and at least one first electronic component soldering district 116 are disposed in the first circuit board 11, in the embodiment of the present invention, there are two first plugging hole districts 115 and two first electronic component soldering districts 116 in the first circuit board 11; Moreover, the surface of the first circuit board 11 can be disposed with at least one first electric circuit 111 and at least one electronic component.

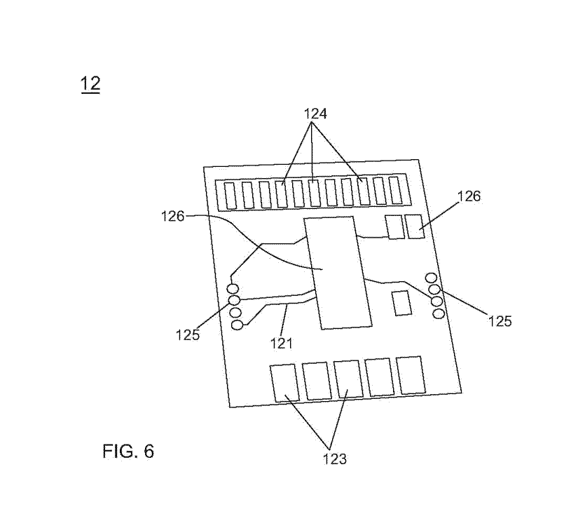

The second circuit board 12 described above is connected to the terminals 102, please referring to FIG. 6 together, which illustrates the top view of the second circuit board of the improved cable connecting device assembly, a second terminal soldering district 123, a second conducting wire soldering district 124, at least one second plugging hole district 125, and at least one second electronic component soldering district 126 are disposed on the second circuit board 12, in the embodiment of the present invention, there are two second plugging hole districts 125 and multi second electronic component soldering districts 126 in the second circuit board 12; Moreover, at least one second electric circuit 121 and the electronic component can be disposed on the second circuit board 12. Referring to FIG. 4 again, the plugging member 13 is disposed between the first circuit board 11 and the second circuit board 12, in the embodiment of the present invention, the plugging member 13 is a pin header connector which is able to electrically connect to the first electric circuit 111 and the second electric circuit 121.

Referring to FIG. 4 again, the cable 14 has a plurality of conducting wires in the interior thereof, the conducting wires can be connected to the first electric circuit 111 and the second electric circuit 121 by soldering, preferably, in the embodiment of the present invention, the length of the second circuit board 12 is longer than the length of the first circuit board 11 in order to facilitate the weld of the conducting wires 141. The sheltering housing 15 is being adapted to cover partial of the electrical connector 10, the first electric circuit 111, the second electric circuit 121, the plugging member 13, and partial of the cable 14. The outer housing 16 is used to wrap the sheltering housing 15, moreover, two screws 161 are respectively disposed on the two sides of the outer housing 16, wherein the two screws 161 can secure the electrical connector 10 on the electronic device when the electrical connector 10 is connected to the electronic device.

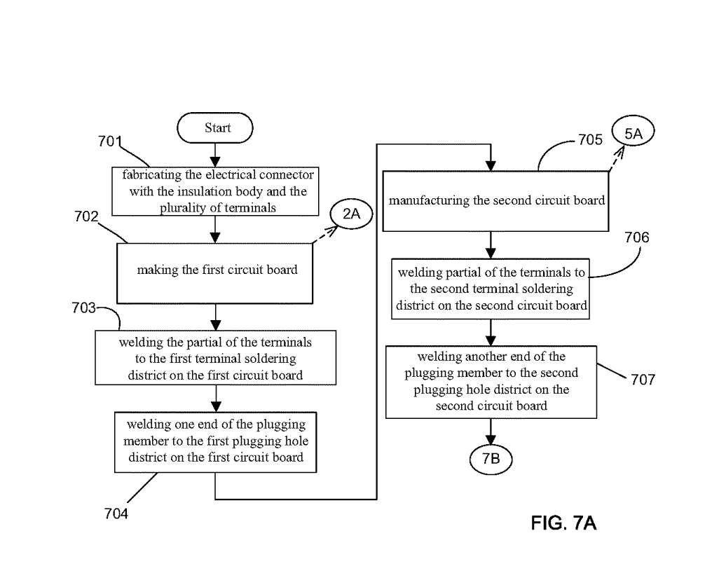

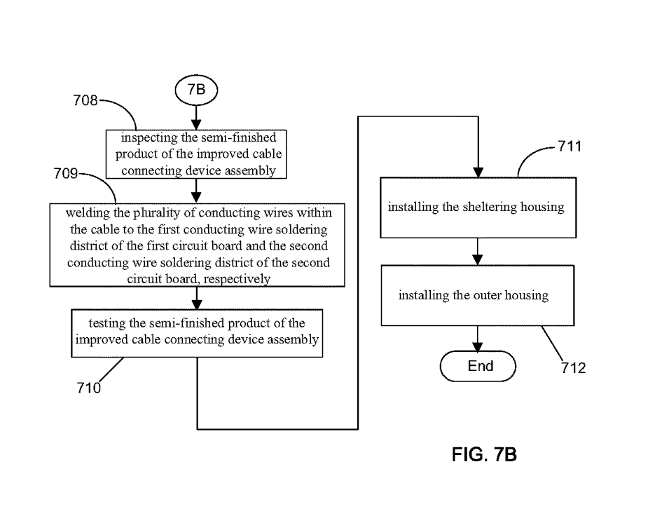

The improved cable connecting device assembly according to the present invention has been disclosed completely and clearly, furthermore, the improved cable connecting device assembly is capable of being fabricated through a specific manufacturing method. Please referring to FIGS. 7A and 7B, which illustrate flow charts of the manufacturing method for the improved cable connecting device assembly according to the present invention, the manufacturing method for the improved cable connecting device assembly 1 includes the steps of:

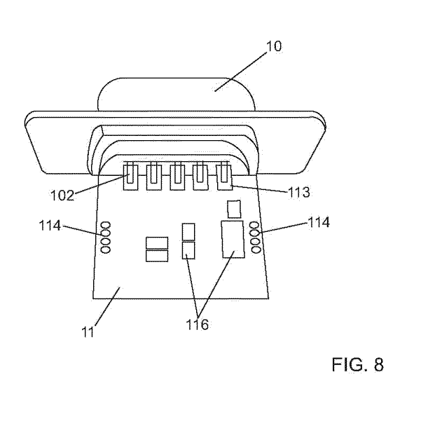

Firstly, executing step (701), fabricating the electrical connector 10 with the insulation body 101 and the plurality of terminals 102; Next to step (702), making the first circuit board 11, as shown in FIG. 5, the first circuit board 11 been made via step (702) includes the first terminal soldering district 113, the first conducting wire soldering district 114, the first plugging hole district 115, and the first electronic component soldering district 116; Continuously executing step (703), welding the partial of the terminals 102 to the first terminal soldering district 113 on the first circuit board 11, referring to FIG. 8, which illustrates the top view of the electrical connector and the first circuit board of the improved cable connecting device assembly, as shown in FIG. 8, the first circuit board 11 has been connected to the electrical connector 10 by way of soldering.

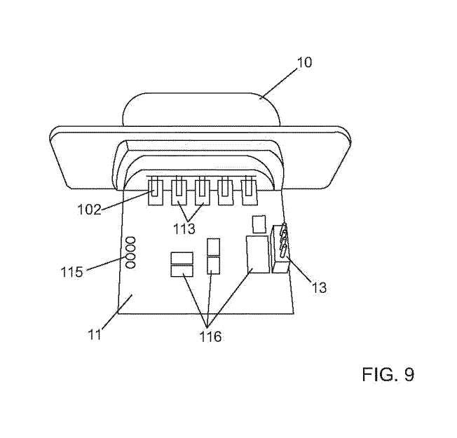

Continuously executing step (704), welding one end of the plugging member 13 to the first plugging hole district 115 on the first circuit board 11, please referring to FIG. 9, which illustrates the top view of the electrical connector, the first circuit board and the plugging member of the improved cable connecting device assembly, due to the plugging member 13 is a kind of the pin header connector and the first plugging hole district 115 has a plurality of holes corresponding to the plugging member 13, so that, as shown in FIG. 9, the plugging member 13 can be fastened on the first plugging hole district 115 steadily by way of welding after the plugging member 13 being plugged on the first plugging hole district 115.

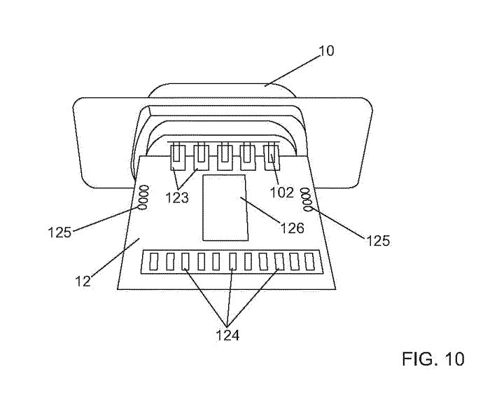

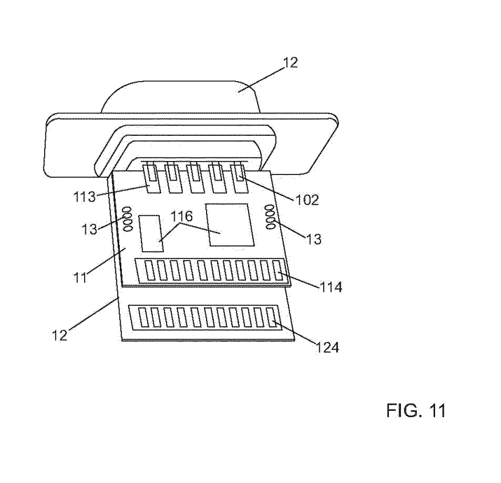

After completing the step (704), next to step (705), manufacturing the second circuit board 12, as shown in FIG. 6, the second circuit board 12 been made by the step (705) including the second terminal soldering district 123, the second conducting wire soldering district 124, the second plugging hole district 125, and the second electronic component soldering district 126. Then executing step (706), welding partial of the terminals 102 to the second terminal soldering district 123 on the second circuit board 12, please referring to FIG. 10, which illustrates the top view of the electrical connector and the second circuit board of the improved cable connecting device assembly, as shown in FIG. 10, the second circuit board 12 has been connected to the electrical connector 10 by way of soldering. Continuously to execute step (707), welding another end of the plugging member 13 to the second plugging hole district 125 on the second circuit board 12; Then executing step (708), inspecting the semi-finished product of the improved cable connecting device assembly 1, please referring to FIG. 11, which illustrates the top view of the electrical connector, the first circuit board, the second circuit board, and the plugging member of the improved cable connecting device assembly, as shown in FIG. 10, it must determine whether each welding point is completely welded when inspecting the semi-finished product of the improved cable connecting device assembly 1.

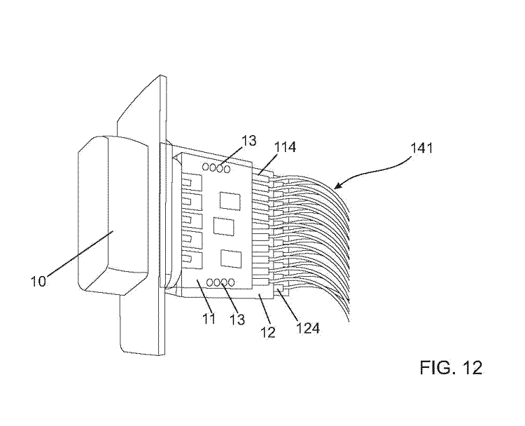

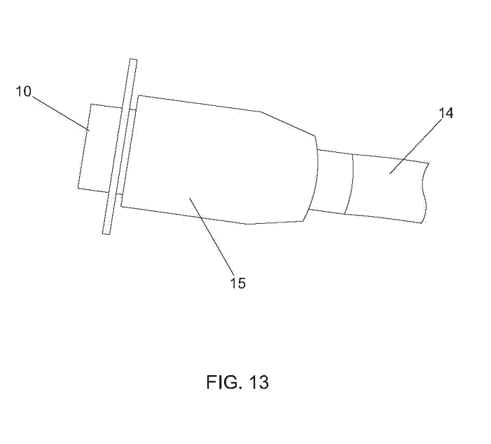

Proceeding to step (709), welding the plurality of conducting wires 141 within the cable 14 to the first conducting wire soldering district 114 of the first circuit board 11 and the second conducting wire soldering district 124 of the second circuit board 12, respectively, please referring to FIG. 12, which illustrates the top view of the electrical connector, the first circuit board, the second circuit board, the plugging member, and the cable of the improved cable connecting device assembly, as shown in FIG. 12, each of the conducting wires 141 must be welded to the first conducting wire soldering district 114 and the second conducting wire soldering district 124; Next to step (710), testing the semi-finished product of the improved cable connecting device assembly 1; Then executing step (711), installing the sheltering housing 15, please referring to FIG. 13, which illustrates the top view of the electrical connector, the cable and the sheltering housing of the improved cable connecting device assembly, as shown in FIG. 13, the sheltering housing 15 covers partial of the electrical connector 10, the first circuit board, the second circuit board, the plugging member, and partial of the cable 14; Finally, executing step (712), installing the outer housing 16, as shown in FIG. 3, the outer housing 16 wraps the sheltering housing 15 and the improved cable connecting device assembly has be fabricated.

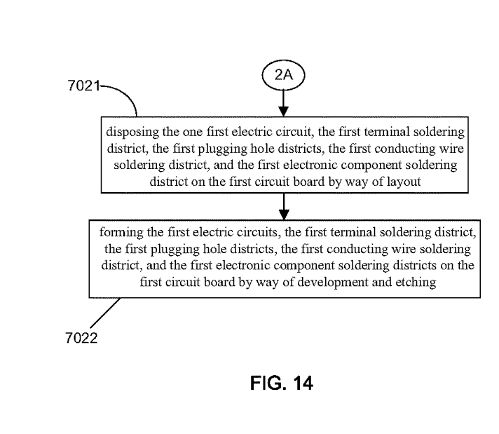

For disclosing the manufacturing method for the improved cable connecting assembly in detail, please referring to FIG. 14, which illustrates the flow chart of the detailed steps of the step (702), the above-mentioned step (702) further includes the detailed steps of:

Firstly, executing step (7021), disposing the one first electric circuit 111, the first terminal soldering district 113, the first plugging hole districts 115, the first conducting wire soldering district 114, and the first electronic component soldering district 116 on the first circuit board 11 by way of layout; And then executing step (7022), forming the first electric circuits 111, the first terminal soldering district 113, the first plugging hole districts 115, the first conducting wire soldering district 114, and the first electronic component soldering districts 116 on the first circuit board 11 by way of development and etching.

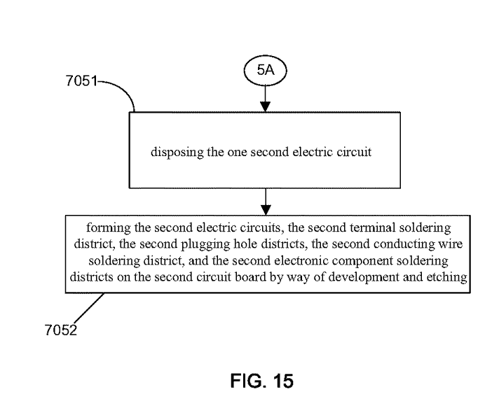

Moreover, for disclosing the manufacturing method for the improved cable connecting assembly in detail, please referring to FIG. 15, which illustrates the flow chart of the detailed steps of the step (705), the above-mentioned step (705) further includes the detailed steps of:

Firstly, executing step (7051), disposing the one second electric circuit 121, the second terminal soldering district 123, the second plugging hole districts 125, the second conducting wire soldering district 124, and the second electronic component soldering district 126 on the second circuit board 12 by way of layout; And then executing step (7052), forming the second electric circuits 121, the second terminal soldering district 123, the second plugging hole districts 125, the second conducting wire soldering district 124, and the second electronic component soldering districts 126 on the second circuit board 12 by way of development and etching.

Thus, the improved cable connecting device assembly and the manufacturing method thereof according to the present invention has been disclosed above completely and clearly. In summary, the present invention has the following advantages:
1. The first circuit board and the second circuit board which both has the electric circuits and the electronic components and are connected to the electrical connector, so as to facilitate the improved cable connecting device assembly possess not only the function of video signal transmission but more other functions.
2. Through the manufacturing method, the improved cable connecting device assembly is fabricated and has not only the function of video signal transmission but more other functions, besides, the whole thickness of the improved cable connecting device assembly is not increased.

The above description is made on an embodiment of the present invention. However, this embodiment is not intended to limit scope of the present invention, and all equivalent implementations or alterations within the spirit of the present invention still fall within the scope of the present invention.

I claim:

1. An improved cable connecting device assembly connected to an electronic device for transmitting signals, comprising:
an electrical connector, having an insulation body and a plurality of terminals, the plurality of terminals being wrapped by the insulation body;
a first circuit board, being connected to the terminals, wherein at least one first electric circuit and at least one electronic component are disposed on the first circuit board;
a second circuit board, being connected to the terminals, wherein at least one second electric circuit and the electronic component are disposed on the second circuit board;
at least one plugging member, being disposed between the first circuit board and the second circuit board and capable of electrically connecting to the first electric circuit and the second electric circuit;
at least one cable, having a plurality of conducting wires which can be connected to the first electric circuit and the second electric circuit by soldering;
a sheltering housing, being adapted to cover parts of the electrical connector, the first electric circuit, the second electric circuit, the plugging member, and part of the cable; and
an outer housing, being used to wrap around the sheltering housing.

2. The improved cable connecting device assembly of claim 1, wherein the first circuit board has a first terminal soldering district, a first conducting wire soldering district, at least one first plugging hole district, and at least one first electronic component soldering district.

3. The improved cable connecting device assembly of claim 1, wherein the second circuit board has a second terminal soldering district, a second conducting wire soldering district, at least one second plugging hole district, and at least one second electronic component soldering district.

4. The improved cable connecting device assembly of claim 1, wherein the plugging member is a pin header connector.

5. The improved cable connecting device assembly of claim 4, wherein the length of the second circuit board is longer than the length of the first circuit board.

6. The improved cable connecting device assembly of claim 1, wherein two screws are disposed on the two sides of the outer housing, respectively.

7. A manufacturing method for an improved cable connecting device assembly, comprising the steps of:
(1) fabricating an electrical connector with an insulation body and a plurality of terminals;
(2) making a first circuit board;
(3) welding the partial of the terminals to a first terminal soldering district on the first circuit board;
(4) welding one end of a plugging member to a first plugging hole district on the first circuit board;
(5) manufacturing a second circuit board;
(6) welding the partial of the terminals to a second terminal soldering district on the second circuit board;
(7) welding another end of the plugging member to a second plugging hole district on the second circuit board;
(8) inspecting the semi-finished product of the improved cable connecting device assembly;
(9) welding a plurality of conducting wires within a cable to a first conducting wire soldering district of the first circuit board and a second conducting wire soldering district of the second circuit board, respectively;
(10) testing the semi-finished product of the improved cable connecting device assembly;
(11) installing a sheltering housing; and
(12) installing an outer housing.

8. The manufacturing method for an improved cable connecting device assembly of claim 7, wherein the step (2) further comprises the steps of:
(21) disposing at least one first electric circuit, the first terminal soldering district, the first plugging hole districts, the first conducting wire soldering district, and at least one first electronic component soldering district on the first circuit board by way of layout; and
(22) forming the first electric circuits, the first terminal soldering district, the first plugging hole districts, the first conducting wire soldering district, and the first electronic component soldering districts on the first circuit board by way of development and etching.

9. The manufacturing method for an improved cable connecting device assembly of claim 7, wherein the step (5) further comprises the steps of:
(51) disposing at least one second electric circuit, the second terminal soldering district, the second plugging hole districts, the second conducting wire soldering district, and at least one second electronic component soldering district on the second circuit board by way of layout; and
(52) forming the second electric circuits, the second terminal soldering district, the second plugging hole districts, the second conducting wire soldering district, and the second electronic component soldering districts on the second circuit board by way of development and etching; and [symbol]
